(19) United States
(12) Patent Application Publication
(10) Pub. No.: US 2004/0170322 A1
(43) Pub. Date: Sep. 2, 2004

(54) Prioritizing in segment matching

(76) Inventors: Piotr Wilinski, Eindhoven (NL); Cornelius Van Overveld, Eindhoven (NL); Fabian Edgar Ernst, Eindhoven (NL)

Correspondence Address: Philips Electronics North America Corporation, Corporate Patent Counsel, PO Box 3001, Briarcliff Manor, NY, 10510, US

(21) Appl. No.: 10/480,658

(22) PCT Filed: Jun. 20, 2002
(86) PCT No.: PCT/IB02/02368

(30) Foreign Application Priority Data
Jun. 29, 2001 (EP) 01202508.6

(51) Int. Cl. G06K 9/46

(52) U.S. Cl. 382/190

(57) ABSTRACT

A method for matching digital images, including regularization of image features of a first digital image, composed of pixels, providing a second digital image, composed of pixels, defining a finite set of candidate values, wherein a candidate value represents a candidate for a possible match between image features of the first image and image features of the second image, establishing a matching penalty function for evaluation of the candidate values, evaluating the matching penalty function for every candidate value, selection of a candidate value based on the result of the evaluation of the matching penalty function, regularization of the first image by segmentation of the first image, including assigning at least part of the pixels of the image to respective segments, determining a pixel importance parameter for at least part of the pixels of a segment, the pixel importance parameter representing the relative importance of each of the pixels, and establishing the matching penalty function to be at least partially based on the pixel importance parameter.

The invention relates to a method according to the introductory section of claim 1.

The matching of two or more images is used in image processing, and consists essentially of determining matching sections in subsequent images. Matching of images is an essential step in several fields of image processing, such as depth reconstruction, image data compression, and motion analysis.

The matching process includes the determination of image features in a first position in a first image, and determining the position of these image features in a second image. The information of the difference in position between the features in the first and second image, such as translation or rotation, can be used in further processing. For example, a translation of an image feature between two subsequent images can be used to get a measure of the speed of an object associated with the image feature.

Image matching can be performed by context independent processing, implemented in universal image processing hard or software for use with for example MPEG (de)coding and television scan rate conversion. In these applications subsequent digital images of a video stream are matched. The general method used in such processing is as follows.

From a video stream two subsequent images are to be matched; let these images be the 2-dimensional digital images I₁(x,y) and I₂(x,y) . The matching of these two images comprises the calculation of a pair of functions M=Mₓ(x,y) and M=M_{y}(x,y), that ideally map every pixel in the image I₁ to a pixel in image I₂, according to

I₁(x,y)=I₂(x+Mₓ(x,y),y+M_{y}(x,y)).

These functions M contain information about how pixels or features have moved between the two images. The functions M can for example be interpreted as the apparent motion of pixels in the video stream, and give a motion vector for each pixel. This motion vector can for example be used in depth reconstruction from 2-dimensional images, in natural motion for scanrate upconversions in television and in MPEG compression. The matching of images therefore consists of finding the functions M.

The definition for M as a function which is defined independently for all pixels causes that the problem of finding M is ill-posed. The construction of M is very problematic and incurs substantial costs, both in time and calculation power, if a function M can be determined at all. To simplify the problem of finding M, regularization of the function M has been proposed. From U.S. Pat. No. 5,072,293 a method is known in which the function M is set to be constant over pre-defined blocks within the images, that are fixed with respect to the image frame. This approach simplifies the problem of finding M, and reduces the costs needed to find function M. A disadvantage of this method is that the calculations still are costly and time consuming, while the accuracy of the obtained solution for M is not sufficient for certain applications.

It is an objective of the invention to provide a method for matching sections of subsequent images that is more effective and faster than the known method.

To meet this objective a method of the above mentioned type is proposed as defined in the characterizing part of claim 1.

According to a first aspect of the invention, after segmenting the first image, wherein the pixels of each image are assigned to respective segments, the value of a pixel importance parameter is determined for at least part of the pixels of a segment. The pixel importance parameter represents the relative importance for matching purposes of each of the pixels. In turn the matching penalty function is based on the pixel importance parameter in such a way that in evaluation of the penalty function more weight is given to important pixels.

In an embodiment, the pixel importance parameter is based on the distance of a pixel to a hard border section of a segment and a visibility parameter. Preferably, only the distance to a relevant border section is used. The relevance of border sections can be determined by evaluation of segment depth values of segments engendered by that border section. If the border section does not coincide with a change in depth, it is likely that that section does not represent important information for matching purposes.

Furthermore, the visibility function deals with whether a pixel in the first image has a corresponding pixel in the second image. Incorporated in the penalty function, the visibility function removes pixels from the process that are obscured in the subsequent image. Obscured pixels can be found by depth values for the segments of the first and second images and determining based on the depth values which higher positioned segments obscure other lower positioned segments.

By using a pixel importance parameter in the penalty function of the matching process, the accuracy of the matching is increased, whereas the required calculation resources are reduced. The invention further relates to a device for matching digital images.

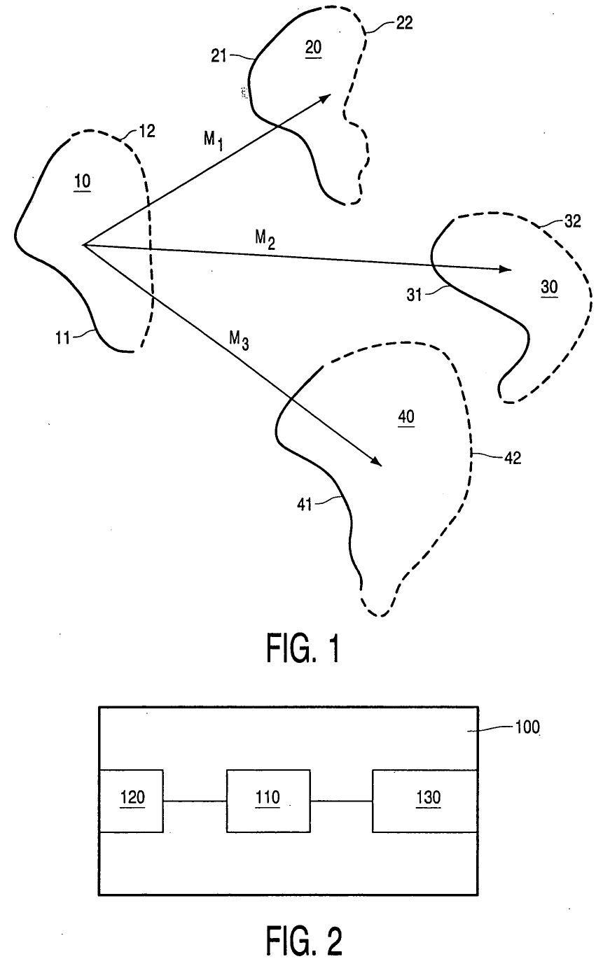

Particularly advantageous elaborations of the invention are set forth in the dependent claims. Further objects, elaborations, modifications, effects and details of the invention appear from the following description, in which reference is made to the drawings, in which FIG. 1 schematically illustrates an example of a segment matching process and FIG. 2 schematically shows a device for matching digital images.

In the following example of an embodiment of the invention, the matching of two images will be explained. These images can be subsequent images from a video stream, but the invention is not limited thereto. The images are digital images consisting of image pixels and defined as two 2-dimensional digital images I₁(x,y), and then I₂(x,y), wherein x and y are the co-ordinates indicating the individual pixels of the images.

The matching of these two images includes the calculation of a pair of functions M=Mₓ(x,y) and M=M_{y}(x,y). M is defined as before as to map every pixel in the image I₁ to a pixel in image I₂, according to the formula

I₁(x,y)=I₂(x+Mₓ(x,y),y+M_{y}(x,y)).

According to the invention, the construction of M is modified by redefining M as a function that is constant for groups of pixels having a similar motion by modifying the previous definition of M by

I₁(x,y)=I₂(x+Mₓ(G(x,y)),y+M_{y}(G(x,y))).

The function G is introduced to keep M constant for a collection of pixels with similar motion. The introduction of the function G is a regularization of the matching problem, which modification significantly reduces the effort required to find M.

A collection of pixels for which M is said to be constant is composed of pixels that are suspected of having a similar motion. To find such collections, the images are divided into segments by means of segmentation. Segmentation of an image amounts to deciding for every pixel in the image, the unique membership to one of a finite set of segments, wherein a segment is a connected collection of pixels. An advantageous method of segmentation is quasi segmentation wherein membership of a pixel to a segment is decided on basis of image related attributes of the pixels such as color, luminance, and texture, and wherein segment boundaries are labeled with a certainty value. Segments that result from quasi segmentation do not necessarily correspond directly with image objects, but the pixels in a certain segment still have a very high probability of having similar motion. A method for quasi segmentation is described in applicants co-pending patent application titled “Segmentation of digital images” by the applicant, the text of which is considered to be incorporated herein by reference. With quasi segmentation images can be segmented very quickly and efficiently.

The image I₁ is divided into segments, by means of the aforementioned method of quasi segmentation, resulting in segments consisting of pixels that are bound by borders defining the respective segment. As a result of quasi segmentation, the segments are defined by hard border sections and soft border sections. Hard border sections result from analysis of image features, and have a high certainty to be a relevant segment border. The soft border sections are determined by means of calculation of distances to detected hard border sections, and therefore have a lower certainty to be a relevant segment border. The better a border section corresponds with the image content, the more relevant that border section is. According to the present invention, the matching of images in the form of matching segments is done with priority for the matching of pixels with a high importance based on their expected information content of the respective segments.

In FIG. 1 a segment 10 of image I₁ is shown, determined by quasi segmentation and bound by a hard border section 11 (indicated by a solid line) and a soft border section 12 (indicated by a dashed line). To determine the displacement function for the segment 10 between image I₁ and image I₂, a projection of the segment 10 in the image I₂ needs to be found that matches segment 10, which yields consequently the displacement function M. This is done by selecting a number of possible match candidates of image I₂ for the match with segment 10, calculating a matching criterion for each candidate and selecting the candidate with the best matching result. The matching criterion is a measure of the certainty that the segment of the first image matches with a projection in the second image. As mentioned before, the hard border sections of the segments have a higher certainty factor than the soft border sections.

Candidates of image I₂ for a match with segment 10 are shown in FIG. 1 as projections 20, 30, 40 of image I₂, bound respectively by hard border sections 21, 31, 41 and soft border sections 22, 32, 42. For each of the projections 20, 30, 40 the function M is indicated by the respective arrows M1, M2, M3. Consequently M1, M2, and M3 can be considered candidate values for the function M. To determine which of the candidate projections 20, 30, 40 matches best with segment 10, a matching criterion has to be calculated for each projection 20, 30, 40. According to the invention, the matching criterion does give more weight to certain pixels of segments in the evaluation of candidate projections and candidate values for M. More weight is given to pixels that have more significance for defining real object boundaries.

The matching criterion is used in digital imaging processing and is known in its implementation as minimizing a matching error or matching penalty function. Such functions and methods of matching by minimizing a matching function per se are known in the art, for example from “Sub-pixel motion estimation with 3-D recursive search block-matching” by De Haan and Biezen, published in Signal Processing: Image Communication 6 (1994) 229-239.

A finite set of i candidates Mₓ and M_{y}, being the function M in both x and y co-ordinates is defined by:

{(M_{x;i},M_{y;i})|i=1,2,3, . . . }.

The selection of a finite set of candidates Mₓ and M_{y} per se is known in the art, for example from the above mentioned publication of De Haan and Biezen. Preferably, the set of candidates is kept small to reduce the number of calculations required to evaluate each candidate. With each candidate a candidate projection is associated.

The collection of pixels in a segment is denoted by Ω. The match penalty MPᵢ for the i-th candidate is defined by:

$${MP}_{i} = {\sum }_{( x , y ) ∈ Ω} \vert {I}_{1} ( x , y ) - {I}_{2} ( x + {M}_{x ; i} , y + {M}_{y ; i} ) \vert . \qquad ( 1 )$$

This match penalty function gives equal weight to every pixel in a segment. As mentioned before, pixels of a segment do not have the same significance in a matching process, as some pixels are highly significant as they represent real object boundaries, and some other pixels are merely associated with textures and therefore unimportant for matching purposes. The importance of various pixels within a segment may for example vary due to their position or distance relative to the nearest edges of the segment, the amount of texture and/or features, and noise. Furthermore, occlusion can occur in which segments partially block other segments, which has as result that pixels may be visible in a first picture, and be invisible in a consequent image, and vice versa. Pixels that are obscured in a subsequent image should not be used for matching since for such pixels there is no counterpart in the subsequent image and they will therefore not be matchable. Taking non-matchable pixels in account will increase the calculation costs of the matching process, and could lead to less accurate results.

Therefore, according to the invention a matching process is provided which takes in account the importance of pixels and the exclusion of invisible pixels.

To take the importance of individual pixels into account using the above devised tools, the match penalty function is revised to read:

$${MP}_{i}^{′} = {\sum }_{( x , y ) ∈ Ω} PIM ( x , y ) \vert {I}_{1} ( x , y ) - {I}_{2} ( x + {M}_{x ; i} , y + {M}_{y ; i} ) \vert . \qquad ( 2 )$$

The weighing function PIM(x,y) is a pixel importance function which assigns a factor to each pixel, that represents the importance of a pixel relative to the expected information content. In this example the weighing function PIM(x,y) reads:

PIM(x,y)=w(x,y)v(x,y), (3)

in which w(x,y) is a weighing function and in which v(x,y) is a visibility function. The importance of a pixel is controlled by the PIM(x,y) function which in this embodiment depends on the visibility map (i.e. v(x,y)) and the weighing function and edge or border ownership (i.e. w(x,y)). As a result, invisible pixels get a zero importance, and other pixels are given an importance parameter based on the distance to a border to which the pixel belongs, only if that border is considered relevant.

To take in account the above described difference in importance as indicated by the depth value of a segment, the weighing function w(x,y) is defined by:

w(x,y)=dist(x,y)own(x,y).

The weighing function therefore comprises two factors: the functions dist(x,y) and own(x,y). dist(x,y) contributes to the weighing function w(x,y) and depends on the distance of a pixel to a border, and own(x,y) relates to the importance of that border.

The function dist(x,y) assigns a weighing factor to a pixel based on the distance to a border, so that pixels with a high certainty contribute more to the evaluation of the penalty function. In the function dist(x,y) the distance d(x,y) of a pixel to a hard border section of the segment is used such that the value of the weighing function w(x,y) decreases with the distance from a hard border section. This represents the assumption that the hard border segments are the most certain features of the image, and that the further a pixel is located from the closest hard border, the less importance it has. For dist(x,y) any suitable function can be chosen, as long as the value of the function decreases with the distance from a segment border.

A number of functions are shown next, as non-limiting examples:

dist(x,y)=1/d(x,y), I.

dist(x,y)=1/d(x,y)², II.

dist(x,y)=1 if d(x,y)<1.5; dist(x,y)=0 if d(x,y)≧1.5, and III.

dist(x,y)=(5−d(x,y))/4 if d(x,y)<5; dist(x,y)=0 if d(x,y)≧5. IV.

Note that all of the functions lead to a decreased value with increasing distance to a hard border section. In case of function III the value is constant over a predetermined distance, and beyond that distance the value is zero, thus also leading to a decreased value with increasing distance. Function III and IV restrict the calculations to only a fixed number of closest pixels; this further decreases the number of calculations required. If the segmentation of the images was performed using the preferred method of quasi segmentation, the distance to the nearest hard border section of the segment to which a pixel belongs is already known from the segmentation process, in the form of the information in the distance array. This leads to the advantage of significantly reduced calculations for the matching process.

Using such a distance parameter gives a good indication of the significance of a certain pixel. Although hard border segments have a high probability to be associated with a real object border, further selection is desirable to get an even better indication of the significance of pixels within a segment. In particular, not all hard border segments are equally relevant for matching purposes. To select the most relevant hard border segments, depth values of adjacent segments bound by a hard border can be used. Two situations are likely when a hard border is determined:

1. The hard border corresponds to a texture feature, characterized by the neighboring segments having the same depth value. These kind of hard border have a very low probability to be a border corresponding with a real object border and are for matching purposes not very relevant. Therefore these hard border sections should not give rise to any value according to the distance function.

2. The hard border corresponds to a discontinuity in depth, indicated by the fact that the respective sides of the hard border have a different depth value. Such hard borders have a very high probability to be a border associated with a real object border, and are highly relevant for matching. For these borders the distance function should be kept as defined before. To this end the ownership function own(x,y) is defined as:

own(x,y)=1 if pixel (x,y) is associated with border of type 2 and

own(x,y)=0 if pixel (x,y) is associated with border of type 1.

For the evaluation mentioned above, an evaluation of a depth value of a segment is required. Methods for determination of depths of segments in an image are know per se in the art. For use with the invention, any suitable method for determination of depth values for images segments may be used. Typically, such methods compare subsequent images and yield a depth value for each segment of an image.

This weighin g w(x,y) function only considers seed points of the hard border sections that correspond to the second group of hard borders that signify a discontinuity in depth. In the evaluation of the function, for each hard border section is determined whether it is of the above mentioned type 1 or 2. Border sections of type 1, i.e. non relevant texture borders, are given a low or zero distance value. Border sections of type 2, i.e. relevant object border sections, are give a high or maximum distance value. Using the weighing function w(x,y) results in that only the pixels associated with a relevant hard border segment are taken into account during matching.

Furthermore, invisible pixels have to be excluded from the matching evaluation as mentioned before. To this end a visibility function v(x,y) is introduced. This visibility function has a value of zero if a pixel will not be visible in the next image, and a pixel will have a value of one if the pixel will be visible in the next image. For determination of the visibility function subsequent images have to be taken into account. The visibility function can be implemented in any suitable way. Typically, determination of the visibility function requires determination of depth values for the segments of the subsequent images and determining based on the depth values which higher positioned segments obscure other lower positioned segments. As the depth values of the segments are also used in the determination of the above mentioned weighing function w(x,y), the required calculation resources can be shared among the processes for the determination of w(x,y) and v(x,y). Consequently, the invisible pixels can be singled out, so that these pixels are not used during the matching calculations.

As described above the visibility function v(x,y) can not be calculated on the basis of a single image, so that to initiate the evaluation according to the invention preferably the following procedure is followed. During the first iteration of the matching, a first set of depth values is computed for v(x,y). These computed depth values allow the segments to be ordered from the closest to the furthest one. As described above, any suitable method for determination of depth values can be employed.

In use, the method according to the invention requires in a first iteration step an estimation for depth values to use equation 3. To start the process start depth values have to be estimated, for which any suitable value can be used. After the initial estimation of the depth values, in consequent iterations former calculated depth values can be used. The method according to the invention then resides in the computation of the weighing function PIM(x,y) on a pixel basis, according to equation (3), and subsequent the determination of the penalty function as defined by equation (2).

In the embodiment shown the PIM(x,y) function is related to the distance of a pixel to a hard border section as well as the visibility function. The invention however is not limited to this example; other methods of assigning importance value to each pixel can also be used. In that case a certainty array (x,y) corresponding with the aforementioned distance array has to be filled with weighing factors for each pixel, related to the segment to which the respective pixels belongs. In particular the invention can be used with only the weighing function w(x,y), without considering the visibility function. Although some efficiency could be lost, less calculation effort is required.

The invention can also be used for matching image sections within a single image, for example for use in pattern or image recognition.

The invention further relates to a computer program product comprising computer program code sections for performing the steps of the method of the invention when run on a computer. The computer program product of the invention can be stored on a suitable information carrier such as a hard or floppy disc or CD-ROM or stored in a memory section of a computer.

The invention further relates to a device 100 shown in FIG. 2 for matching digital images. The device 100 is provided with a processing unit 110 for matching digital images according to the method as described above. The processing unit 110 may be designed as an at least partly programmable device or may be designed to implement one or more of the above described algorithms in hardware. The processing unit 110 is connected with an input section 120 by which digital images can be received and put through to the unit 110. The unit 110 is further connected to an output section 130 through the resulting found matches between images can be outputted.

The device 100 may be incorporated in a display apparatus such as a television apparatus, in particular a three-dimensional (3-D) television for displaying 3-D images or video. The device 100 may further be included in a motion estimator of an encoding apparatus. Anther advantageous application is a 3-D scanner.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements, and by means of a suitably programmed computer. In a device claim enumerating several means, several of these means can be embodied by one and the same item of hardware. The mere fact that certain measures are recited in mutually different dependent claims does not indicate that a combination of these measures cannot be used to advantage.

1. A method for matching digital images, the method including
regularization of image features of a first digital image (I₁), composed of pixels,
providing a second digital image (I₂), composed of pixels,
defining a finite set of candidate values (M_{x;i},M_{y;i}), wherein a candidate value represents a candidate for a possible match between image features of said first image and image features of said second image,
establishing a matching penalty function (MP′ᵢ) for evaluation of said candidate values (M_{x;i},M_{y;i}),
evaluating the matching penalty function (MP′ᵢ) for every candidate value (M_{x;i},M_{y;i}),
selection of a candidate value (M_{x;i},M_{y;i}) based on the result of the evaluation of the matching penalty function,
characterized by
regularization of said first image by segmentation of said first image (I₁), including assigning at least part of the pixels of said image (I₁) to respective segments (10),
determining a pixel importance parameter (PIM(x,y)) for at least part of the pixels of a segment (10), said pixel importance parameter(PIM(x,y)) representing the relative importance of each of said pixels, and
establishing the matching penalty function (MP′ᵢ) to be at least partially based on the pixel importance parameter (PIM(x,y)).

2. A method according to claim 1, wherein the pixel importance parameter (PIM(x,y)) includes a weighing parameter (w(x,y)) based on the distance (d(x,y)) of a pixel to a hard border section (11) of a segment (10, 20, 30, 40) and a visibility parameter (v(x,y)).

3. A method according to any of the preceding claims,
further comprising determination of relevance of border sections (11), wherein the weighing parameter (w(x,y)) is based on the distance to a relevant border section (11).

4. A method according to claim 3, wherein the relevance of a border section (11) is determined by evaluation of segment (10, 20, 30, 40) depth values of segments (10, 20, 30, 40) engendered by that border section (11).

5. A method according to claim 2, wherein the visibility parameter (v(i,j)) indicates whether a pixel in the first image (I₁) has a corresponding pixel in the second image (I₂).

6. A method according to claim 5, wherein determination of the visibility parameter (v(i,j)) comprises determination of depth values for the segments of the first and second images (I₁, I₂) and determining based on the depth values which closer positioned segments obscure other further positioned segments.

7. A method according to any of the claims 1-2, wherein the segmentation is achieved by means of quasi segmentation.

8. Computer program product comprising program code sections for performing the steps of any one of the claims 1-2 when run on a computer.

9. Device for matching digital images with
a processing unit (110) for matching digital images according to a method according to any one of claims 1-2, the processing unit being provided with an input section (120) for receiving digital images (I₁,I₂), and an output section (130) for outputting matching results.

10. Apparatus comprising a device according to claim 9.
